(19) United States
(12) Patent Application Publication
(10) Pub. No.: US 2002/0196942 A1
(43) Pub. Date: Dec. 26, 2002

(54) Location-based information for computer files and messages

(76) Inventor: Raymond J. Werner, Portland, OR (US)

Correspondence Address: SCHWABE, WILLIAMSON & WYATT, P.C., 10260 SW GREENBURG ROAD, SUITE 820, PORTLAND, OR, 97223, US

(21) Appl. No.: 09/888,822

(22) Filed: Jun. 22, 2001

(51) Int. Cl. H04K 1/00

(52) U.S. Cl. 380/258

(57) ABSTRACT

A location-aware product includes a location information resource for providing the present location of the location-aware product to within some margin of error, and the present location information is included by the location-aware product in various outputs, including but not limited to, location stamps in files for create, open, and/or modify file operations, and signature blocks in email or other documents. In a further aspect, location information may be included in email such as in an automatically applied signature block. The location-aware product may be a computer, a personal digital assistant, a cellular telephone, or any such product that includes location-awareness. The location information resource may be a Global Positioning System module that provides at least latitude and longitude. In one aspect of the invention a map database is used to convert latitude and longitude to the geographical name of the location specified by the latitude and longitude.

### Background of the Invention

1. Field of the Invention

The methods and apparatus of the present invention relate generally to the field of location-based services, and more particularly to applications of location information for location-aware products.

2. Background

The deployment in modern times of communication satellites in earth orbit, such as those which form the well-known Global Positioning System (GPS), have enabled, first, military systems, and subsequently, commercial systems to use signals from orbiting satellites to determine their location on earth. In this way, the navigation of military and commercial vehicles by automatic guidance systems has been facilitated.

In addition to guidance system applications, signals from the Global Positioning System have been used in conjunction with various hardware and software products for providing terrestrial coordinates to users such as hikers or backpackers who want or need to know their locations. Similarly, fleets of trucks have been equipped with GPS systems so that their location can be monitored.

As the application and acceptance of GPS based location systems has grown the cost of such GPS hardware and software has begun to decline. With declining prices, it is anticipated that the deployment of such location information resources in a wide variety of electronic products will become feasible.

What is needed are practical uses for such location information resources in consumer products, such as, but not limited to mobile consumer electronics devices.

### SUMMARY OF THE INVENTION

Briefly, a location-aware product includes a location information resource for providing the present location of the location-aware product to within some margin of error, and such present location information is included by the location-aware product in various outputs, including but not limited to, location stamps in files for create, open, and/or modify file operations, and signature blocks in email or other documents. In a further aspect, location information may be included in email such as in an automatically applied signature block. The location-aware product may be a computer, a personal digital assistant, a cellular telephone, or any such product that includes location-awareness. The location information resource may be a Global Positioning System module that provides at least latitude and longitude. In one aspect of the invention a map database is used to convert latitude and longitude to the geographical name of the location specified by the latitude and longitude.

### BRIEF DESCRIPTION OF THE DRAWINGS

FIG. 1 is a block diagram representation of a computer equipped with an exemplary module that provides location information to the computer in accordance with the present invention.

FIG. 2 is a flowchart of an illustrative process in accordance with the present invention that incorporates location information into a file in connection with a file open operation.

FIG. 3 is a flowchart of an illustrative process in accordance with the present invention that incorporates location information into a file in connection with a both a file open and a file modify operation.

FIG. 4 is a flowchart of an illustrative process in accordance with the present invention that incorporates location information into a file in connection with a file modify operation.

FIG. 5 is a flowchart of an illustrative process in accordance with the present invention that incorporates location information in a cookie file.

FIG. 6 is a flowchart of an illustrative process in accordance with the present invention that reads location information from a cookie file.

FIG. 7 is a flowchart of an illustrative process in accordance with the present invention that incorporates location information in a signature block of an email message.

FIG. 8 is a flowchart of an illustrative process in accordance with the present invention that includes converting latitude and longitude information into geographical name information and inserting that geographical name information into a signature block of an email message.

### DETAILED DESCRIPTION

Generally, various embodiments of the present invention may obtain location information from a location information resource, such as but not limited to, a GPS receiver and processing circuitry, incorporate that location information into one or more files, such as, but not limited, to text files, email files, word processing files, and so on; or 2) subsequently provide such stored location information to a display, such as, but not limited to, a directory listing of files that includes the location of creation or modification of the file, in addition to, or in place of, other file parameters such as, for example, file size, file type, or time of creation or modification of the file.

Reference herein to “one embodiment”, “an embodiment”, or similar formulations, means that a particular feature, structure, or characteristic described in connection with the embodiment, is included in at least one embodiment of the present invention. Thus, the appearances of such phrases or formulations herein are not necessarily all referring to the same embodiment. Furthermore, various particular features, structures, or characteristics may be combined in any suitable manner in one or more embodiments.

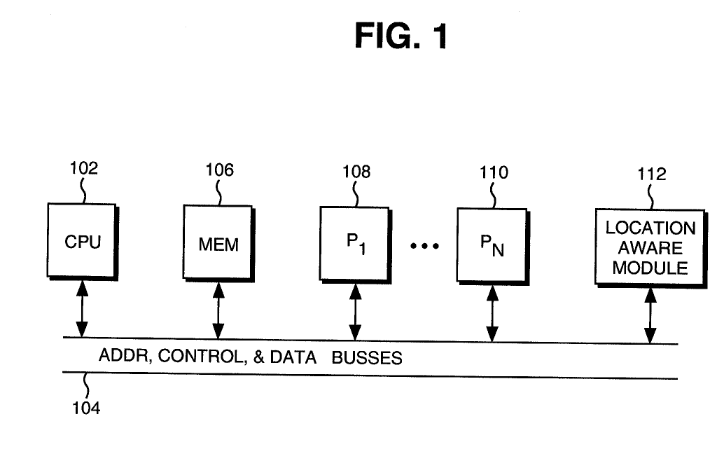

FIG. 1 is a block diagram representation of a computer equipped with an exemplary module that provides location information to the computer in accordance with the present invention. More particularly, a central processing unit (CPU) 102 is shown coupled to a bus 104. Similarly, a memory 106, peripherals 108,110, and a location-aware module 112 are included in the computer and are also coupled to bus 104. It should be noted that various other computer or digital system architectures may be used in accordance with the present invention. For example, some computer systems use a different bus to couple system memory to the CPU, than is used to couple peripheral devices to the CPU, and such systems may be used in embodiments of the present invention. In the illustrated embodiment, location-aware module 112 includes a GPS receiver and processing circuitry to convert the received GPS signals into location coordinates, such as, but not limited to, latitude and longitude. An antenna suitable for receiving GPS signals is typically included within location-aware module 112, but such antenna may be spaced apart from location-aware module 112. If the antenna is spaced apart from location-aware module 112, then the antenna is appropriately coupled to module 112. Although FIG. 1 represents a computer equipped with a location resource, it will be understood, that this functionality may be included in a wide variety of electronic products, including consumer products, that include some computational capability, such as, but not limited to, cellular phones, personal digital assistants (PDA), electronic games, and so on. It will be further understood, that the utility of the present invention is greatest in mobile devices (e.g., laptop computer cellular phones, personal digital assistants (PDA), and electronic games) but the invention is not limited to devices that are typically mobile.

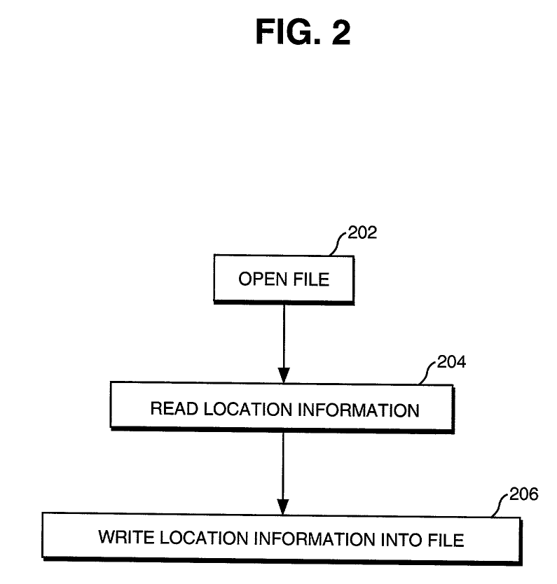

FIG. 2 is a flowchart of an illustrative process in accordance with the present invention that includes (i.e., inserts or incorporates) location information into a file in connection with a file open operation. More particularly, in this embodiment, a file is opened 202. File open operations are common in computer systems and are well understood. Such a file open operation is commonly initiated by a computer user by, for example, double-clicking on an iconic representation of the file in a graphical user interface. It is known that there are other means of opening files, including the opening of files by an operating system without the need for specific user action. Files opened in this way include, but are not limited to, text files, word processing files, spreadsheet files, database files, sound files, graphics files, video files, and so on. Subsequent to, or concurrent with, the opening of the file, location information is read 204 from a location information resource, such as the location-aware module 112 of FIG. 1. It is within the scope of the present invention to read the location information prior to the file opening, however, this may result in location information that is not contemporary with the actual location of the computer at the time that the file is open. Subsequent to reading the location information, at least a portion of the location information is written into the file 206. All the information obtained from the location resource may be written to the file, but depending on the particular implementation, the location resource may provide other information that does not need to be included in the file, such as information on altitude, time of day, speed, and so on. It is a designer's choice as to how much location and location-related data obtained from the location resource to include in the file. In a presently preferred embodiment, latitude and longitude information are stored in the file. In this way, a translation from latitude/longitude information, to geographical place name can be performed when the file is read. In this way, another aspect of the present invention is supported. That is, providing the geographical place name in the language of the present location. In other words, if a file on a laptop computer is opened in the United States, and the latitude/longitude information are included in the file, then on subsequent accesses of the file, it may be determined where that file open operation took place, and that location displayed in English if the laptop is still in the United States, but however, it may be displayed in French if the current location of the laptop is somewhere in France. Of course, other implementations of the present invention may elect to perform a latitude/longitude to geographical place name translation at the time of originally reading the latitude/longitude information, and incorporating the text of the geographical place name into the file. The location information is read from the location information resource is indicative of the physical location of the computer. The location information may be in any suitable format, and such formats include, but are not limited to, latitude/longitude, and geographical location name. It will be understood that although a computer is used in this example, other the present invention applies to other electronic devices, such as for example mobile consumer electronic devices, as well.

It should be noted that reading location information from location-aware module 112 is similar to reading information from any commonly available type of computer peripheral device. For example, one or more fixed addresses in a memory, or I/O space, of a computer may be read and the resulting data represents the location information. In an alternative embodiment, a command is written to location-aware module 112 and as a consequence, location information is transferred by location-aware module 112 to some pre-determined address. Those skilled in the art will appreciate that communication between a CPU and peripheral device in a computer system is a well-understood matter.

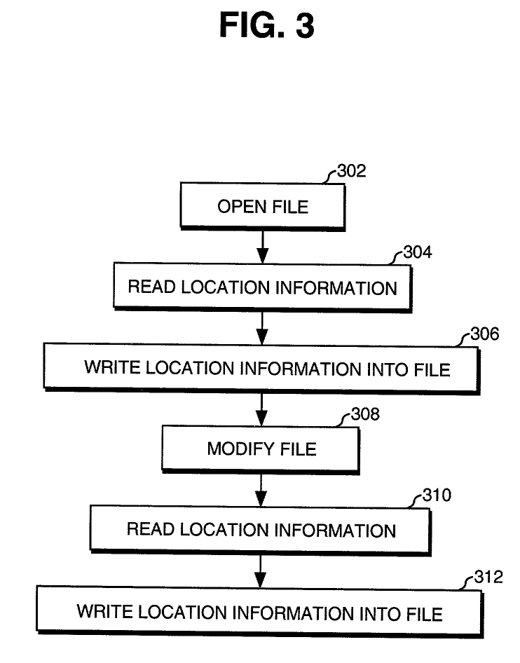

FIG. 3 is a flowchart of an illustrative process in accordance with the present invention that includes (i.e., inserts or incorporates) location information into a file in connection with a both a file open (as shown in FIG. 2) and a file modify operation. More particularly, in this embodiment, a file is opened 302. Subsequent to, or concurrent with, the opening of the file, location information is read 304 from a location information resource, such as location-aware module 112 of FIG. 1. Subsequent to reading the location information, at least a portion of the location information is written 306 into the file. The location information read from the location information resource is indicative of the physical location of the computer. The location information may be in any suitable format, and such formats include, but are not limited to, latitude/longitude, and geographical location name. In this embodiment of the present invention, the file that was opened at 302 is now modified 308. Subsequent to, or concurrent with, the modification of the file, location information is read 310 from the location information resource. Subsequent to reading the location information, at least a portion of the location information is written 312 into the file. In this example, the incorporated location information is appropriately labelled as being associated with the file open operation or with the file modify operation. The computer system may include a history of location information associated with each open or modify operation, or only the most recent open or modify operation, or a combination. These implementation specific options can be chosen by the system designer, or can be made a user definable option in the computer system, similar to the user selecting a preferred screensaver, or desktop color.

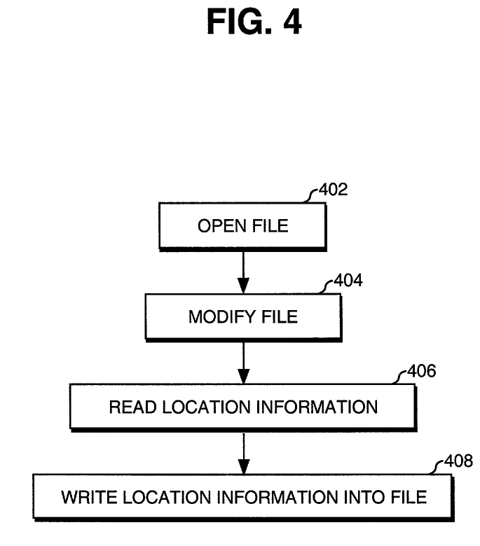

FIG. 4 is a flowchart of an illustrative process in accordance with the present invention that includes (i.e., inserts or incorporates) location information into a file in connection with a file modify operation. More particularly, in this embodiment, a file is opened 402. Subsequent to the opening of the file, the file is modified 404. Location information is read 406 from a location information resource, such as location-aware module 112 of FIG. 1. Subsequent to reading the location information, at least a portion of the location information is written 408 into the file. The location information read from the location information resource is indicative of the physical location of the computer. The location information may be in any suitable format, and such formats include, but are not limited to, latitude/longitude, and geographical location name. This example is similar to that described in connection with FIG. 3, but does not include incorporating location information in connection with file open operations.

FIGS. 2 through 4 provide illustrative embodiments of the present invention. In a further aspect of the present invention, various embodiments including reading back the location information that was written into the files and displaying or otherwise utilizing that information. Location information that was stored, either in an opened or modified file, or some other file (e.g., a system file maintained by the computer's operating system) that is associated with the opened or modified file, can be read back and displayed alone or with other file attributes such as, for example, the date and time of the file open or modify operation. When a directory listing is obtained that includes location information, the directory listing may be sorted according to location, whether by latitude, longitude, alphabetically in accordance with geographical place name, or by regions (e.g., North America, Western Europe, Asia, and so on).

The operations writing and reading back location information from files, as described above, are typically implemented in software. Such software may be included in a computer's operating system, or may be installed on a computer as an application program.

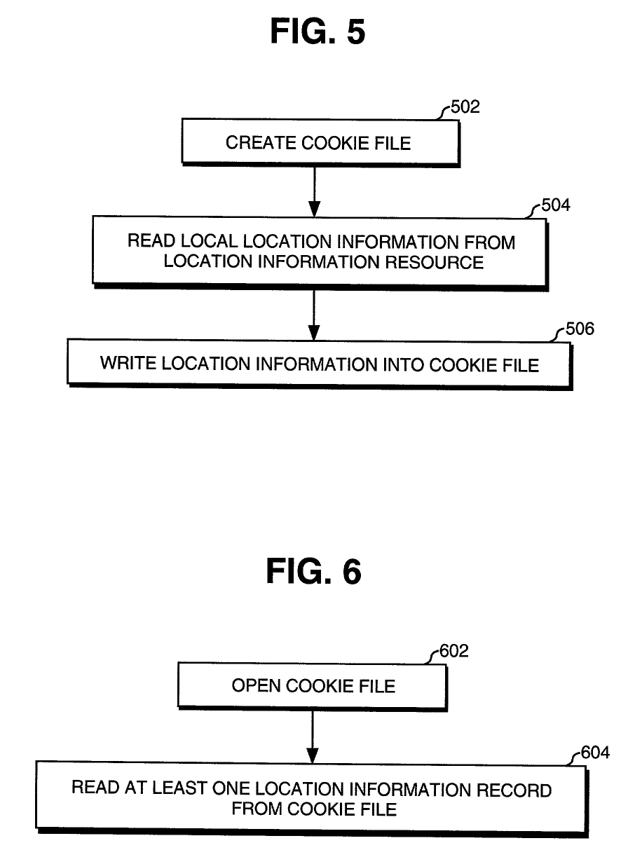

FIG. 5 is a flowchart of an illustrative process in accordance with the present invention that incorporates location information in a cookie file. Cookies or cookie files are terms that describe files stored on a client computer because of an interaction between, for example, a web browser software program running on the client computer, and a software program than runs on a web server computer. Typically such an interaction occurs when a computer user visits, or accesses a web site. Cookies are generally relatively small files that allow the software running on the web server to determine whether and when the client computer has accessed the web site. In one embodiment of the present invention, a cookie file is created on a client computer 502. Location information is obtained 504 from a location information resource present (such as, for example, location information resource 112 of FIG. 1) in the client computer. This location information is indicative of the location of the client computer at the time of the interaction with the web site. The location information may be in any suitable format, and such formats include, but are not limited to, latitude/longitude, and geographical location name. The location information is then written 506 into the cookie file. Such information in the cookie file can be useful to a web site operator in determining geographical usage patterns of the web site, i.e., from where the site is being accessed. Furthermore, the location information may be updated upon subsequent accesses of the cookie file. Similarly, a history, or log, of location information may be formed in the cookie file by additional accesses of the cookie file during, or as a consequence of, one or more interactions with the web site.

FIG. 6 is a flowchart of an illustrative process in accordance with the present invention that reads location information from a cookie file. More particularly, a cookie file that includes location information relative to where the client computer was located at the time the cookie file was created, last opened, or last modified, is opened 602. The cookie file may be opened in connection with a visit to a web site, or such similar interaction with a web server, or other computer system or process. Subsequently, at least one item of location information is read 604 from the cookie file. The location information may constitute a record in the file, although no particular file format is required by the present invention. The location information read from the cookie file may be transmitted back to the web server, mentioned above, so that geographical usage patterns may be determined. Methods and apparatus for communication between a web browser (client) and a web site (server) are well known and are not described further herein.

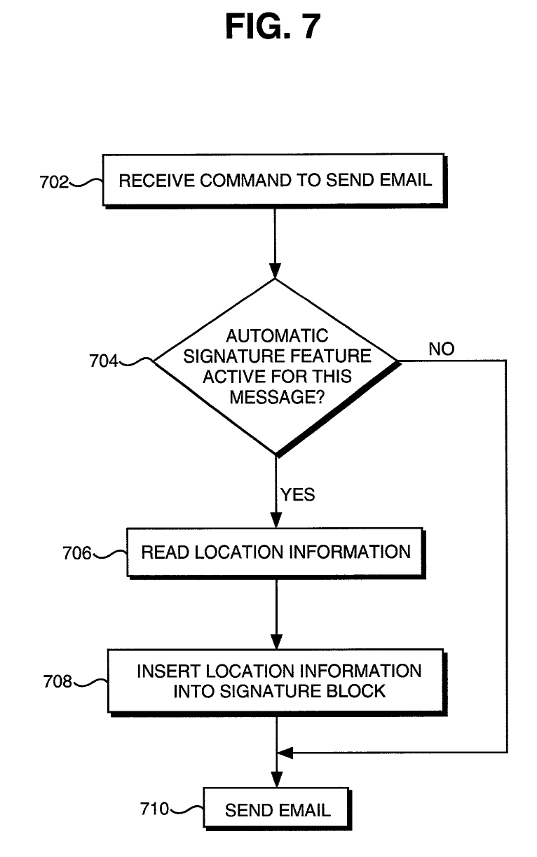

FIG. 7 is a flowchart of an illustrative process in accordance with the present invention that incorporates location information into a signature block of an email message. Some of the well-known and widely available email programs provide users with a feature that automatically appends a signature block to their email. These signature blocks are typically defined by the email users and often include information such as, but not limited to, the name of the user, the user's phone number and address, business title, mail-stop, and so on. In this example, a computer system, or other information handling device, having a location information resource (such as location information resource 112 of FIG. 1), and capable of preparing and sending email, receives a command to send an email 702. A decision is then made 704 as to whether such an automatic signature feature is active for this message. If the automatic signature feature is not active, then the email is sent 710. If the automatic signature feature is active, then the current location of the computer, or other information handling device is obtained from the location information resource 706. That location information is appended to, or inserted into, the email message, for example into the signature block 708. The email is then sent 710. It is to be understood, that in this context sending an email may mean actually transmitting the email to another computer or information handling device, directly or through some communication network, or simply spooling the email for subsequent transmission.

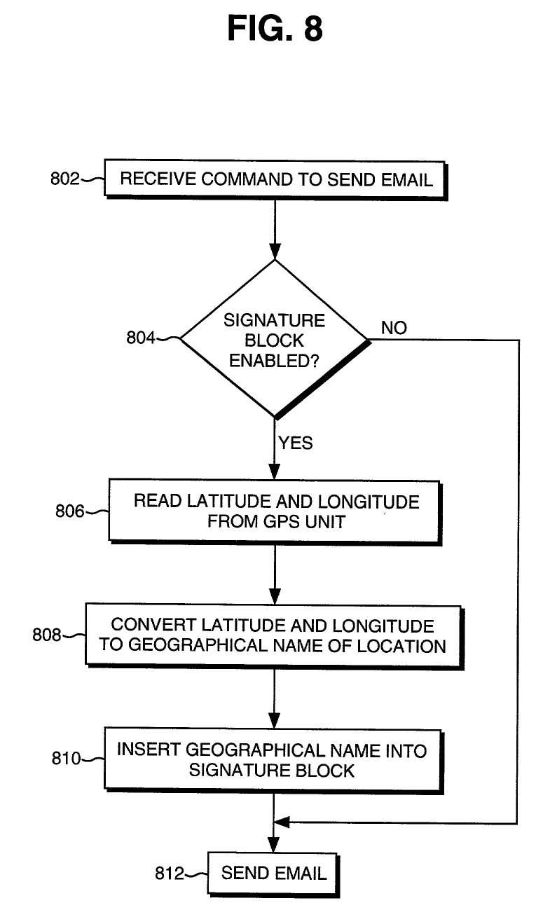

FIG. 8 is a flowchart of an illustrative process in accordance with the present invention that includes converting latitude and longitude information into geographical name information and inserting that geographical name information into a signature block of an email message. This example is similar to the general example of FIG. 7, but illustrates a more specific example. More particularly, a computer system or other information handling device, having a location information resource (such as location information resource 112 of FIG. 1), and capable of preparing and sending email, receives a command to send an email 802. A decision is then made 804 as to whether a signature block feature is active for this message. If the signature block feature is not active, then the email is sent 812. If the signature block feature is active, then the current location of the computer or other information handling device, in the format of latitude and longitude, is obtained from the location information resource 806. The latitude and longitude information are then converted to a geographical place name of the location that corresponds to the latitude and longitude 808. The geographical place name information is then inserted into the signature block 810. The email with the included geographical name information is then sent 812. It is to be understood, that in this context sending an email may mean actually transmitting the email to another computer, or information handling device, directly or through some communication network, or simply spooling the email for subsequent transmission.

The present invention may be implemented as circuit-based processes, including possible implementation on a single integrated circuit. As would be apparent to one skilled in the art, various functions of circuit elements may also be implemented as processing operations in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as punched cards, magnetic tape, floppy disks, hard disk drives, CD-ROMs, flash memory cards, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It is to be understood that the present invention is not limited to the embodiments described above, but encompasses any and all embodiments within the scope of the following claims.

What is claimed is:

1. A method of providing location history to computer files, comprising:
opening a file;
reading location information from a location information resource; and
writing the location information to the file.

2. The method of claim 1, wherein the location information resource is a peripheral device in a computer system.

3. The method of claim 2, wherein the peripheral device is a Gloobal Positioning System (GPS) module.

4. The method of claim 2, wherein opening the file comprises one or more operations by a computer operating system.

5. The method of claim 4, wherein the location information comprises latitude and longitude.

6. The method of claim 4, wherein the location information comprises one or more geographical place names.

7. The method of claim 4, further comprising reading the location information previously written to the file.

8. A method of incorporating geographical information in an email, comprising:
a) receiving, in a computer system, a command to send an email;
b) determining if an automatic signature feature is active for the email;
c) sending the email if the determination in (b) is negative; and
d) reading location information from a location information resource within the computer system, and inserting the location information into a signature block of the email if the determination in (b) is affirmative.

9. The method of claim 8, wherein the location information resource is a GPS module.

10. The method of claim 8, wherein the location information comprises latitude and longitude.

11. The method of claim 8, wherein the location information comprises geographical place name information.

12. The method of claim 10, further comprising converting latitude and longitude information into geographical place name information.

13. A method of obtaining information about the geographical pattern of client usage of a web site, comprising:
creating a file on a client computer in connection with an interaction with a web server;
reading location information from a location information resource in the client computer;
storing the location information in the file.

14. The method of claim 14, wherein the file is a cookie file.

15. The method of claim 13, wherein the location information resource is a GPS module, and the location information is latitude and longitude.

16. The method of claim 13, further comprising reading location information from the file and communicating that location information to the web server.

17. The method of claim 15, further comprising reading location information from the file and communicating that location information to the web server.
